(19) United States
(12) Patent Application Publication
(10) Pub. No.: US 2024/0098349 A1
(43) Pub. Date: Mar. 21, 2024

(54) TRANSLATABLE HOUSINGS

(71) Applicant: Hewlett-Packard Development Company, L.P., Spring, TX (US)

(72) Inventors: Chih Chien Chen, Taipei City (TW); Paul Lalinde, Spring, TX (US); Robert J. Kelley, Spring, TX (US)

(73) Assignee: Hewlett-Packard Development Company, L.P., Spring, TX (US)

(21) Appl. No.: 18/262,116

(22) PCT Filed: Jan. 28, 2021
(86) PCT No.: PCT/US2021/015400

§ 371 Date: Jul. 19, 2023

(51) Int. Cl. H04N 23/51; G06F 1/16; H04N 23/80

(52) U.S. Cl. CPC H04N 23/51; G06F 1/1607; H04N 23/80

(57) ABSTRACT

In some examples, an apparatus can include a housing, a tilt structure connected to the housing, a swivel structure connected to the tilt structure, and a rail structure connected to the swivel structure, where the rail structure comprises a sliding mechanism to interface with a track such that the housing is translatable along the track.

### BACKGROUND

Computing devices can allow a user to utilize computing device operations for work, education, gaming, multimedia, and/or other uses. Computing devices can be utilized in a non-portable setting, such as at a desktop, and/or be portable to allow a user to carry or otherwise bring with the computing device with while in a mobile setting. These computing devices can include imaging devices that can be utilized to provide video and/or audio conferencing between computing devices and/or generate images that can be transferred between computing devices.

### BRIEF DESCRIPTION OF THE DRAWINGS

FIG. 1 is a back view of an example of an apparatus including a translatable housing consistent with the disclosure.

FIG. 2 is a side section view of an example of an apparatus including a housing, a tilt structure, a swivel structure, and a rail structure including a sliding mechanism and a track for translatable housings consistent with the disclosure.

FIG. 3A is a side section view of an example of an apparatus including a housing, a swivel structure, and a rail structure including a sliding mechanism including a channel beam for translatable housings consistent with the disclosure.

FIG. 3B is a side section view of an example of an apparatus including a rail structure including a sliding mechanism having a bearing for translatable housings consistent with the disclosure.

FIG. 3C is a side section view of an example of an apparatus including a rail structure including a sliding mechanism interfacing with a pulley wheel for translatable housings consistent with the disclosure.

FIG. 4A is a perspective view of an example of a housing connected to a tilt structure oriented in a first position and including a tilt ramp and a protrusion for translatable housings consistent with the disclosure.

FIG. 4B is a perspective view of an example of a housing connected to a tilt structure oriented in a second position and including a tilt ramp for translatable housings consistent with the disclosure.

FIG. 5 is a perspective view of an example of a housing connected to a tilt structure including a tilt ramp and a spindle for translatable housings consistent with the disclosure.

FIG. 6 is a perspective view of an example of a system including a computing device housing and a detail view of a housing, tilt structure, swivel structure, and a rail structure for translatable housings consistent with the disclosure.

FIG. 7A is a perspective view of an example of a swivel hinge for translatable housings consistent with the disclosure.

FIG. 7B is a perspective view of an example of a swivel hinge, a swivel plate, and an electrical pathway for translatable housings consistent with the disclosure.

FIG. 8 is a perspective view of an example of a housing being rotated relative to a computing device housing for translatable housings consistent with the disclosure.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, an aft-in-one (AIO) computer, among other types of computing devices.

In some examples, the computing devices can utilize imaging devices to capture images. As used herein, the term “imaging device” is a device that can capture or record visual images. In some examples, the imaging device can include a camera or similar device to capture images. For example, the imaging device can be a video camera (e.g., such as a web camera, among other examples) to record a plurality of images that can be in a video format. Although video cameras are utilized as examples herein, the disclosure is not so limited.

Imaging devices included for use with a computing device may be located in a fixed position as part of the computing device. For example, the imaging device may be fixed to a particular location which can prevent movement to other locations. As such, adjustment of the imaging device to effectively capture images can be difficult for a user. Further, in an example in which a user desires to capture images in multiple areas, a device would have to include two imaging devices. Such approaches can be cost prohibitive.

Translatable housings according to the disclosure can allow for an apparatus that can include an imaging device to be moved according to a user's desired placement. Such an apparatus can be connected to a housing of a computing device and be able to translate, tilt, and/or rotate relative to the housing of the computing device. Such translation, tilt, and swiveling can allow for a user to effectively position the housing including the imaging device to capture images effectively. Further, a user may swivel the imaging device to capture images on multiple sides of the computing device so that multiple imaging devices do not have to be included. Translatable housings according to the disclosure can therefore provide an easily manipulated imaging device that can provide cost savings as compared with previous approaches.

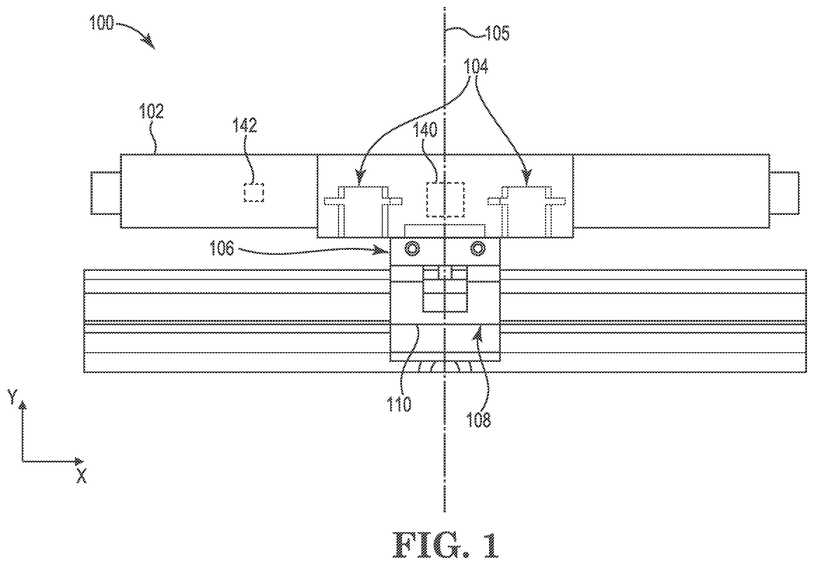

FIG. 1 is a back view of an example of an apparatus 100 including a translatable housing 102 consistent with the disclosure. As illustrated in FIG. 1, the apparatus 100 can include a housing 102, a tilt structure 104, a swivel structure 106, and a rail structure 108.

The apparatus 100 can include a housing 102. As used herein, the term “housing” refers to an outer shell of a device. For example, the housing 102 can be an outer shell that includes other components. Such components can include, for example, an imaging device 140. As described above, the imaging device 140 can be utilized to capture images. For example, a user of a computing device including the housing 102 can utilize the imaging device 140 during a video conferencing call, capture still images, etc.

As described above, the housing 102 can include an imaging device 140. The imaging device 140 can be, for example, an infrared (IR) camera, among other types of imaging devices.

The housing 102 can further include a sensor 142. As used herein, the term “sensor” refers to a device to detect events and/or changes in its environment and transmit the detected events and/or changes for processing and/or analysis. For example, the sensor 142 can detect events/changes around the environment of the housing 102. The sensor 142 can be used in addition to the imaging device 140 to further or deepen the user experience while utilizing the imaging device 140. For example, the sensor 142 can be a microphone to detect audible inputs (e.g., spoken by a user) during a videoconference call. However, examples of the disclosure are not limited to a microphone. For instance, sensor 142 can be an activity sensor (e.g., to detect movement around the housing 102), a color sensor (e.g., to modify graphics displayed on a user interface of a display of a computing device associated with the housing 102), a Time-of-Flight sensor (e.g., to wake-up the computing device associated with the housing 102), among other types of sensors. Further, although one sensor 142 is illustrated in FIG. 1, examples of the disclosure are not so limited. For example, the housing 102 can include multiple sensors 142 that may be different types of sensors.

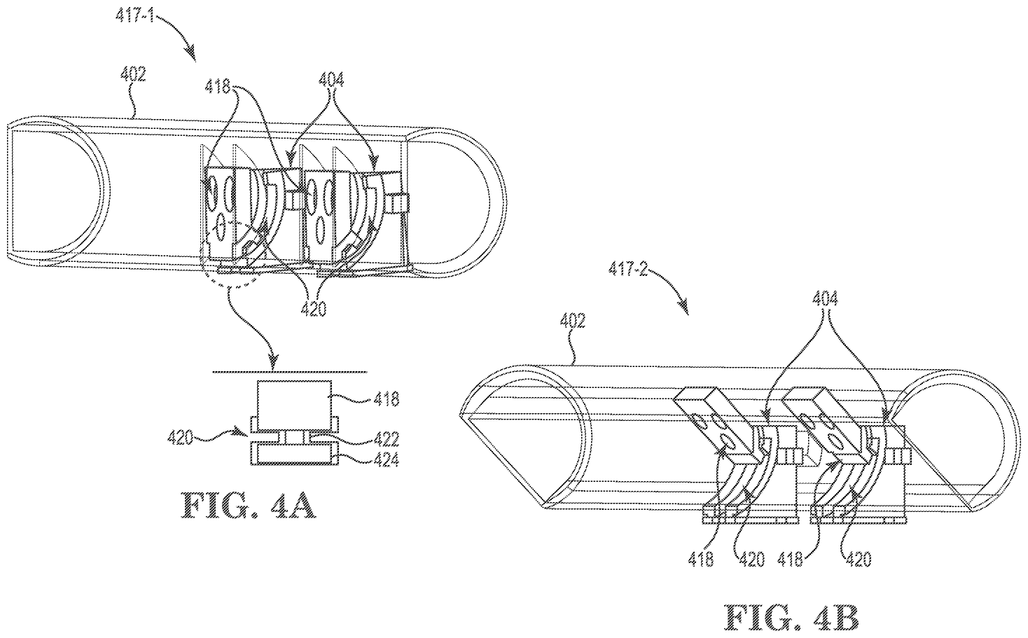

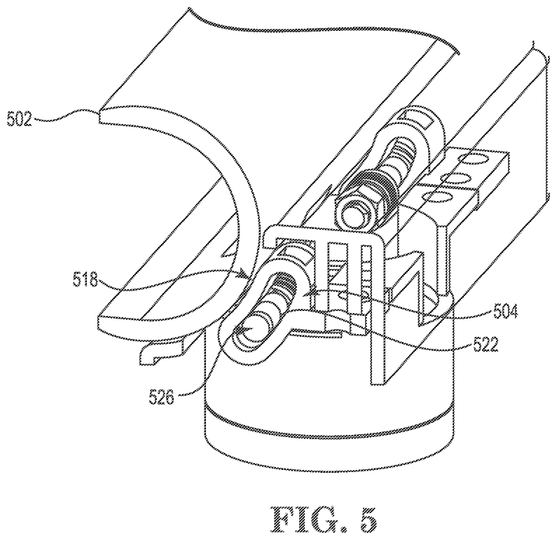

The housing 102 can be connected to a tilt structure 104. As used herein, the term “structure” refers to an arrangement of component parts to enable a body to be rotated about an axis. For example, the tilt structure 104 can be utilized to cause the housing 102 to rotate (e.g., to tilt) up (e.g., in a positive “Y” direction as indicated by the “Y” axis in FIG. 1) and/or rotate down (e.g., in a negative “Y” direction as indicated by the “Y” axis in FIG. 1) in order to change a viewing angle of the imaging device 140, as is further described in connection with FIGS. 4A, 4B, and 5.

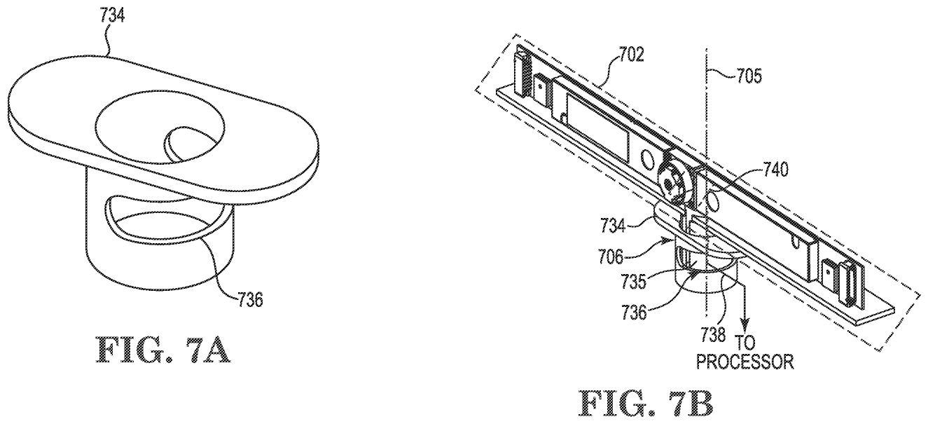

The tilt structure 104 can be connected to a swivel structure 106. The swivel structure 106 can be utilized to cause the housing 102 to rotate (e.g., to swivel) about the axis 105 illustrated in FIG. 1. Such axis 105 can be a central axis for a swivel hinge (e.g., not illustrated in FIG. 1) as is further described in connection with FIGS. 7A and 7B, and translate as the swivel structure 106, tilt structure 104, and housing 102 translate via the rail structure 108 as is further described herein.

The swivel structure 106 can be connected to a rail structure 108. The rail structure 108 can be utilized to cause the housing 102 to translate. For example, the rail structure 108 can enable the housing 102 to translate right (e.g., in a positive “X” direction as indicated by the “X” axis in FIG. 1) and/or translate left (e.g., in a negative “X” direction as indicated by the “X” axis in FIG. 1) in order to change a position of the imaging device 140.

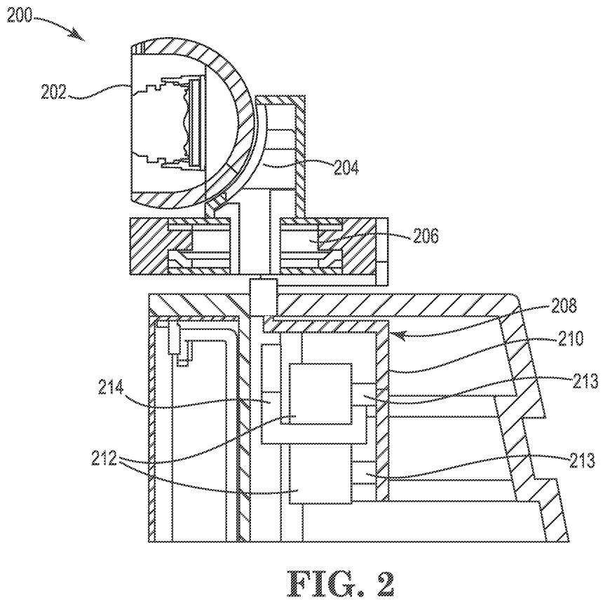

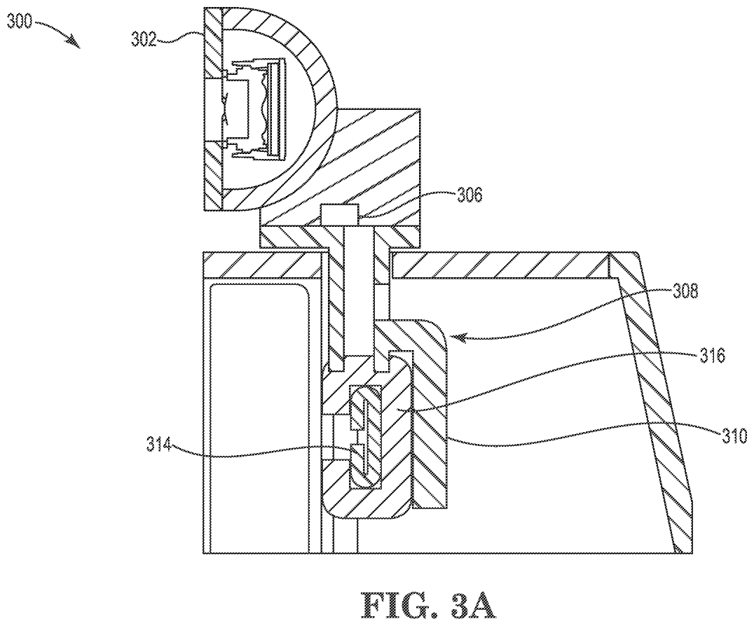

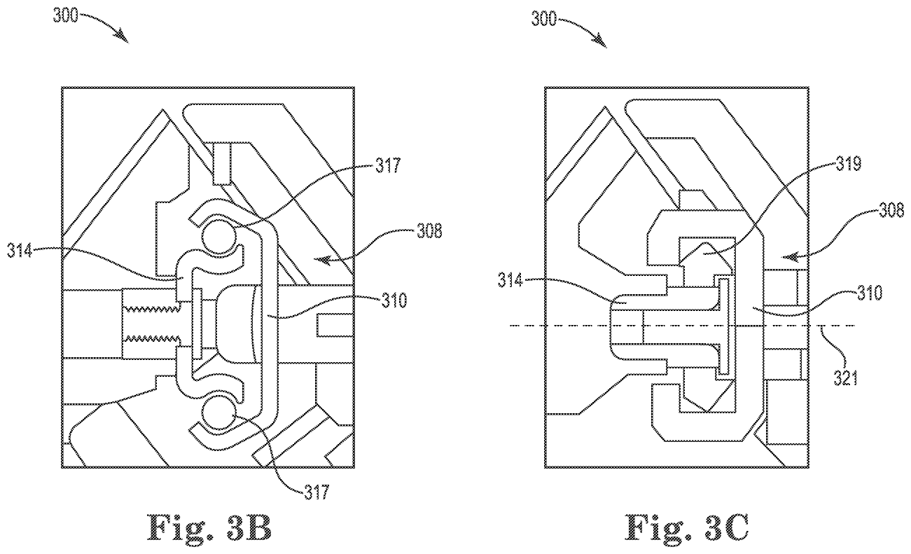

The rail structure 108 can include a sliding mechanism 110. As used herein, the term “sliding mechanism” refers to a device to enable an object to move along in continuous contact with another surface. For example, the sliding mechanism 110 can interface with a track (e.g., as is further described in connection with FIGS. 2 and 3) such that the housing 102 is translatable along the track. The sliding mechanism 110 can therefore enable the housing 102 to translate right and/or left (e.g., as indicated by the positive and/or negative “X” direction indicated by the “X” axis in FIG. 1, respectively).

The tilt structure 104, the swivel structure 106, and/or the rail structure 108 can be of a durable material to enable long-term use of the apparatus 100 without structural breakdown. For example, the tilt structure 104, the swivel structure 106, and/or the rail structure 108 can be of a metal material to allow for tilting of the housing 102 (e.g., via the tilt structure 104), rotation of the housing 102 (e.g., via the swivel structure 106), and/or translation of the housing 102 (e.g., via the rail structure 108) for a lifecycle of the apparatus 100 without structural failure of either the tilt structure 104, the swivel structure 106, and/or the rail structure 108. Further, the metal of the tilt structure 104, the swivel structure 106, and/or the rail structure 108 can be utilized for heat dissipation. For example, the imaging device 140 and/or the sensor 142 may generate an amount of heat that can be dissipated by the tilt structure 104 that is metal, the swivel structure 106 that is metal, and/or the rail structure 108 that is metal.

Although the tilt structure 104, the swivel structure 106, and/or the rail structure 108 are described above as being of a metal material, examples of the disclosure are not so limited. For example, the tilt structure 104, the swivel structure 106, and/or the rail structure 108 can be of a polymer material or any other type of material.

FIG. 2 is a side section view of an example of an apparatus 200 including a housing 202, a tilt structure 204, a swivel structure 206, and a rail structure 208 including a sliding mechanism 210 and a track 214 for translatable housings consistent with the disclosure. The rail structure 208 can further include wheels 212.

As illustrated in FIG. 2, the sliding mechanism 210 can include wheels 212. As used herein, the term “wheel” refers to a circular disc arranged to revolve on an axis. The wheels 212 can interface with the track 214. As used herein, the term “track” refers to a structure which defines a line of travel for another object. For example, the wheels 212 can interface with the track 214 such that the wheels 212 can rotate about an axis in response to the housing 202, the tilt structure 204, and the swivel structure 206 translating along the track 214.

The wheels 212 can be connected to the sliding mechanism 210 (e.g., and therefore the rail structure 208) via axles 213. As used herein, the term “axle” refers to a shaft by means of which a wheel rotates. For example, as mentioned above the wheels 212 can rotate about an axis defined by the axles 213.

Although the sliding mechanism 210 is illustrated in FIG. 2 as including two wheels 212, examples of the disclosure are not so limited. For example, the sliding mechanism 210 can include one wheel 212 or more than two wheels 212. In an example in which the sliding mechanism 210 can include more than two wheels 212, the sliding mechanism 210 may include two additional wheels connected to the sliding mechanism 210 and located in a direction “into” the page as oriented in FIG. 2. As another example, the sliding mechanism 210 may include one wheel 212 (e.g., the upper wheel 212) and a further wheel 212 to interface with the track 214 and located on the sliding mechanism 210 in a direction “into” the page as oriented in FIG. 2.

As illustrated in FIG. 2, the track 214 can be a “C” shape to receive the upper wheel 212. For example, the track 214 can be shaped to receive the upper wheel 212 and guide the upper wheel 212 in a substantially straight direction (e.g., as indicated by the “X” axis previously illustrated in FIG. 1) when the housing 202, the tilt structure 204, and the swivel structure 206 translate along the track 214.

The track 214 can be of a metal material. The metal material of track 214 can allow for translation of the sliding mechanism 210 for a lifecycle of the apparatus 200 without structural failure of the track 214. In some examples, the track 214 can allow for heat dissipation as previously described in connection with FIG. 1. However, examples of the disclosure are not limited to the track 214 being of a metal material. For instance, the track 214 can be any other type of material (e.g., polymer, etc.)

Although the track 214 is illustrated in FIG. 2 as including a single rail, examples of the disclosure are not so limited. For example, as illustrated in FIG. 2, the track 214 can include the rail 214 that is “C” shaped located below the upper wheel 214, and may further include another rail (e.g., a second “C” shaped rail) that can be located above the upper wheel 214 (e.g., as oriented in FIG. 2) to encompass the upper wheel 214 within the two “C” shaped rails. In such an example, the sliding mechanism 210 can include two wheels 214 as illustrated in FIG. 2 or can include a single wheel 214 encompassed within the two “C” shaped rails.

In some examples, the sliding mechanism 210 can include a drum instead of wheels 212. As used herein, the term “drum” refers to a substantially cylindrical object. The drum can interface with the track 214 such that the drum can slide along the track 214 in response to the housing 202, the tilt structure 204, and the swivel structure 206 translating along the track 214.

Similar to the example above, the sliding mechanism 210 can include a single drum or two drums. Additionally, in an example in which the track 214 includes two rails that are both “C” shaped, the two “C” shaped rails can encompass a single drum within the two “C” shaped rails or can include two drums, one outside of the two “C” shaped rails and a single drum within the two “C” shaped rails.

In some examples, the track 214 can include a lubricant to enable the drum or the wheels 212 to slide along the track 214. Such a lubricant can reduce friction between the drum or the wheels 212 when the housing 202, the tilt structure 204, and the swivel structure 206 translate along the track 214.

FIG. 3A is a side section view of an example of an apparatus 300 including a housing 302, a swivel structure 306, and a rail structure 308 including a sliding mechanism 310 including a channel beam 316 for translatable housings consistent with the disclosure. The channel beam 316 can interface with a track 314.

As illustrated in FIG. 3A, the sliding mechanism 310 of the rail structure 308 can include a channel beam 316. As used herein, the term “channel beam” refers to a rigid member having a substantially C-shaped cross section. As illustrated in FIG. 3A, the channel beam 316 can be “C” shaped and can interface with the track 314 to slide along the track 314 in response to the housing 302, the tilt structure (e.g., not illustrated in FIG. 3A), and the swivel structure 306 translating along the track 314.

In the example illustrated in FIG. 3A, the track 314 can also be “C” shaped. The channel beam 316 can accordingly be shaped to encompass the shape of the track 314. The track 314 can then guide the channel beam 316 in a substantially straight direction (e.g., as indicated by the “X” axis previously illustrated in FIG. 1) when the housing 302, the tilt structure (e.g., not illustrated in FIG. 3A), and the swivel structure 306 translate along the track 314.

FIG. 3B is a side section view of an example of an apparatus 300 including a rail structure 308 including a sliding mechanism 310 having a bearing 317 for translatable housings consistent with the disclosure. The bearing 317 can interface with a track 314.

As illustrated in FIG. 3B, the sliding mechanism 310 can include a bearing 317. As used herein, the term “bearing” refers to a device that directs motion of an object. For example, the bearing 317 can be a device that directs motion of the sliding mechanism 310. The bearing 317 can be, for example, a ball bearing.

The bearing 317 can interface with the track 314. Interfacing with the track 314 can allow the bearing 317 to allow the sliding mechanism 310 (and the rail structure 308) to slide along the track 314 in a substantially straight direction (e.g., as indicated by the “X” axis previously illustrated in FIG. 1) when the housing, the tilt structure, and the swivel structure (e.g., not illustrated in FIG. 3B) translate along the track 314.

FIG. 3C is a side section view of an example of an apparatus 300 including a rail structure 314 including a sliding mechanism 310 interfacing with a pulley wheel 319 for translatable housings consistent with the disclosure. The sliding mechanism 310 can interface with the pulley wheel 319.

As illustrated in FIG. 3C, the sliding mechanism 310 can interface with a pulley wheel 319. As used herein, the term “pulley wheel” refers to a disc arranged to revolve around an axis to direct motion of an object. For example, the pulley wheel 319 can be a disc that rotates about axis 321 that directs motion of the sliding mechanism 310.

The pulley wheel 319 can interface with the sliding mechanism 310. Interfacing with the sliding mechanism 310 can allow the pulley wheel 319 to allow the sliding mechanism 310 (and the rail structure 308) to slide along the track 314 in a substantially straight direction (e.g., as indicated by the “X” axis previously illustrated in FIG. 1) when the housing, the tilt structure, and the swivel structure (e.g., not illustrated in FIG. 3B) translate along the track 314.

FIG. 4A is a perspective view of an example of a housing 402 connected to a tilt structure 404 oriented in a first position 417-1 and including a tilt ramp 420 and a protrusion 424 for translatable housings consistent with the disclosure.

The tilt structure 404 can be utilized to cause the housing 402 to tilt up or down. Such tilting of the housing 402 can allow for a viewing angle of an imaging device (e.g., not illustrated in FIG. 4A) to be modified, as is further described herein.

The tilt structure 404 can include an attachment plate 418. As used herein, the term “attachment plate” refers to a piece of material that can be secured to another object. For example, the attachment plate 418 can be connected to the housing 402 to secure the housing 402 to the tilt structure 404.

The tilt structure 404 can further include a tilt ramp 420. As used herein, the term “tilt ramp” refers to a concave slope that can direct movement of another object according to the concave slope. For example, the tilt ramp 420 can interface with the attachment plate 418 such that the tilt ramp 420 can direct movement of the attachment plate 418 (e.g., and the housing 402) according to the concave slope (e.g., curving inward) of the tilt ramp 420. The housing 402 can be tiltable via the tilt ramp 420, as is further described herein.

The tilt ramp 420 can include a tilt track 422. As used herein, the term “tilt track” refers to a structure that defines a line of tilt travel for another object. For instance, the tilt track 422 can define a concave line of travel for the attachment plate 418 (e.g., and the housing 402).

The attachment plate 418 can include a protrusion 424. The protrusion 424 can interface with the tilt track 422. For example, the protrusion 424 can be shaped to interface with (e.g., fit into) the tilt track 422. The tilt track 422 can accordingly direct the protrusion 424 (e.g., and the attachment plate 418) such that the protrusion 424 is translatable along the tilt track 422. Translation of the protrusion 424 along the tilt track 422 can cause the housing 402 to be tiltable via the tilt ramp 420. For example, as the protrusion 424 translates in the tilt track 422, the tilt track 422 can cause the attachment plate 418 (e.g., and therefore the housing 402 including an imaging device not illustrated in FIG. 4A) to angle downwards. For example, as illustrated in FIG. 4A, the tilt structure 404 can be in a first position 417-1. As the protrusion 424 is translated in the tilt track 422, the housing 402 can tilt downwards (e.g., as illustrated in FIG. 4B).

FIG. 4B is a perspective view of an example of a housing 402 connected to a tilt structure 404 oriented in a second position 417-2 and including a tilt ramp 420 for translatable housings consistent with the disclosure.

As previously described in connection with FIG. 4A, the tilt structure 404 can be utilized to cause the housing 402 to tilt up or down. For example, as illustrated in FIG. 4B, the tilt structure 404 can allow for a protrusion of the attachment plate 418 to translate along a tilt track of the tilt ramp 420 to cause the housing 402 to tilt. For example, the tilt structure 404 can tilt from the first position 417-1 (e.g., as illustrated in FIG. 4A), which may be at −5° rotation as measured relative to horizontal (e.g., 5° pointed upwards relative to horizontal) to the second position 417-2 which may be at 45° rotation as measured relative to horizontal (e.g., 45° pointed downwards relative to horizontal). Such tilting of the housing 402 can allow for adjustment of an imaging device included in the housing 402. For example, a second user may utilize a computing device having the housing 402 that may be shorter than a first user and can tilt the housing 402 so that a viewing angle of the imaging device can be modified in order to effectively capture images of the second user.

Further, although the degrees of rotation are described above as being from −5° (e.g., pointed upwards relative to horizontal) to 45° (e.g., pointed downwards relative to horizontal), examples of the disclosure are not so limited. For example, the upper rotation amount can be more than −5° or less than −5° (e.g., 0°) and the downward rotation amount can be more than 45° or less than 45° (e.g., 30°).

FIG. 5 is a perspective view of an example of a housing 502 connected to a tilt structure 504 including a tilt ramp 520 and a spindle 526 for translatable housings consistent with the disclosure. The housing 502 can be connected to the tilt structure 504 via the attachment plate 518.

The tilt structure 504 can include the attachment plate 518 connected to the housing 502 and the tilt ramp 520 to interface with the attachment plate 518 such that the housing 502 is tiltable via the tilt ramp 520. In order to interface with the tilt track 522, in some examples the attachment plate 518 can include a spindle 526. As used herein, the term “spindle” refers to a rod-shaped object. The spindle 526 can be shaped to interface with (e.g., fit into) the tilt track 522.

The tilt track 522 can accordingly direct the spindle 526 (e.g., and the attachment plate 518) such that the spindle 526 is translatable along the tilt track 522. Translation of the spindle 526 along the tilt track 522 can cause the housing 502 to be tiltable via the tilt track 522. For example, as the spindle 526 translates in the tilt track 522, the tilt track 522 can cause the attachment plate 518 (e.g., and therefore the housing 502 including an imaging device not illustrated in FIG. 5) to angle downwards or upwards to allow for adjustment of an imaging device included in the housing 502.

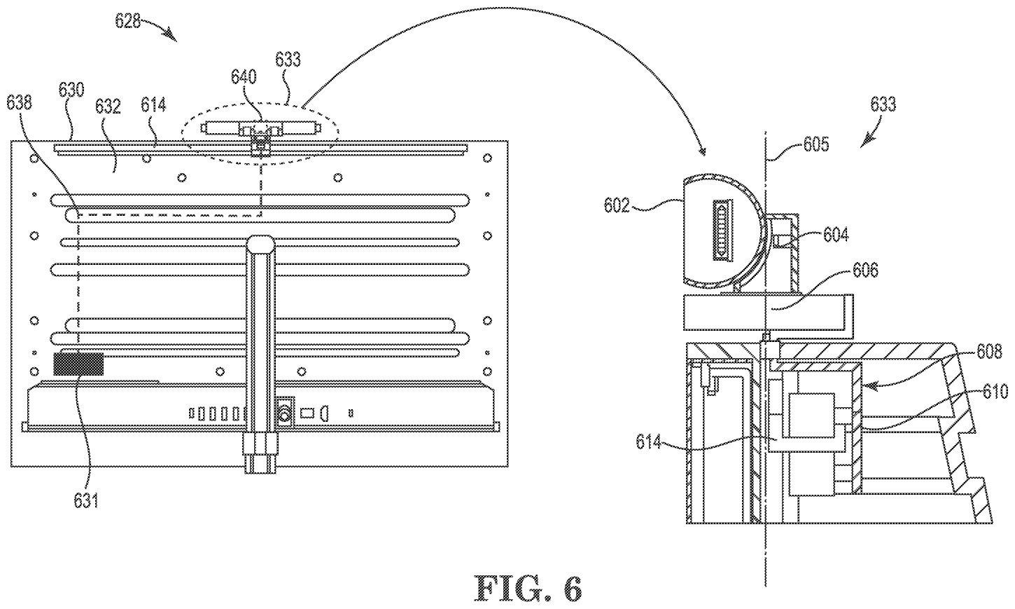

FIG. 6 is a perspective view of an example of a system 628 including a computing device housing 630 and a detail view of a housing 602, tilt structure 604, swivel structure 606, and a rail structure 608 for translatable housings consistent with the disclosure. The computing device housing 630 can include a processor 631 and a frame 632.

As illustrated in FIG. 6, the computing device housing 630 can include a frame 632. As used herein, the term “frame” refers to a rigid structure to support other objects. The frame 632 can be, for example, a chassis used to support components included in the computing device housing 630.

The track 614 can be a portion of the frame 632. For example, the track 614 can be connected to and supported by the frame 632 of the computing device housing 630. The track 614 can interface with the sliding mechanism 610 of the rail structure 608, as is further described herein.

The system 628 can include an imaging device housing 633. The imaging device housing 633 can comprise a housing 602 including an imaging device 640. As previously described above, the imaging device 640 can be utilized to capture images and/or audio. In order to effectively capture images and/or audio, the imaging device housing 633 can be tiltable, rotatable, and/or translatable, as is further described herein.

As illustrated in the close-up view of the imaging device housing 633, the imaging device housing 633 can include a housing 602. The housing 602 can be connected to the tilt structure 604. The housing 602 can be tiltable via the tilt structure 604. For example, the imaging device 640 can be pointed upwards or downwards by tilting the housing 602 via the tilt structure 604. Such tilting can allow for precise vertical placement of the imaging device 640 to effectively capture images and/or audio for a user.

The tilt structure 604 can be connected to the swivel structure 606. The swivel structure 606 can allow the housing 602 and the tilt structure 604 to be rotatable about the swivel structure 606. For example, the housing 602 and the tilt structure 604 can rotate about the axis 605. Such rotation can allow for the imaging device 640 to capture images of a user in front of the computing device housing 630 and behind the computing device housing 630. For example, a building visitor may be photographed by the imaging device 640 for an access badge, and a security guard may simply rotate the housing 602 from the front side of the computing device housing 630 to the back side of the computing device housing 630 to photograph the building visitor. Once finished, the security guard can rotate the housing 602 back to the front side of the computing device housing 630.

The rail structure 608 can be connected to the swivel structure 606. The rail structure 608 can include the sliding mechanism 610 that can interface with the track 614. Utilizing the sliding mechanism 610 interfaced with the track 614, the housing 602, the tilt structure 604, the swivel structure 606, and the rail structure 608 are translatable along the track 614. For example, the housing 602, the tilt structure 604, the swivel structure 606, and the rail structure 608 can be translatable left or right relative to the center position of the imaging device housing 633 as illustrated in FIG. 6. Such translation can allow a user to position the imaging device housing 633 so that the imaging device 640 can effectively capture images and/or audio for a user.

The imaging device 640 can be electrically connected to the processor 631 via an electrical pathway 638. As used herein, the term “electrical pathway” refers to a route which can include a conductive material to carry electric current. The electrical pathway 638 can carry electrical current through a conductive material that can be routed from the imaging device 640, through an aperture of a swivel hinge included in the swivel structure 606 (e.g., as is further described in connection with FIGS. 7A and 7B), to the processor 631. The electrical pathway 638 can be, for example, a flexible cable, among other types of electrical pathways.

In some examples, the imaging device housing 633 can be detachable. For example, the imaging device housing 633 may be detachable from the computing device housing 630. The imaging device housing 633 may be detached when the computing device housing 630 is to be transported, stored, cleaned, etc. The imaging device housing 633 may be reattached to the computing device housing 630.

FIG. 7A is a perspective view of an example of a swivel hinge 734 for translatable housings consistent with the disclosure. The swivel hinge 734 can include an aperture 736.

As illustrated in FIG. 7A, the swivel hinge 734 can include an aperture 736. As used herein, the term “swivel hinge” refers to a device on which another object rotates. For example, the swivel hinge 734 can allow for the rotation of another object (e.g., a swivel plate, as is further described in connection with FIG. 7B).

The aperture 736 can be utilized to route an electrical pathway from an imaging device through the aperture 736 to a processor. For example, as previously described in connection with FIG. 6, an imaging device can be connected to a processor via an electrical pathway. The electrical pathway can include a conductive material that can be routed through the aperture 736, as is further described in connection with FIG. 7B. The aperture 736 can be shaped such that the electrical pathway can rotate with the swivel plate and maintain the electrical connection.

FIG. 7B is a perspective view of an example of a swivel hinge 734, a swivel plate 735, and an electrical pathway 738 for translatable housings consistent with the disclosure. The swivel plate 735 can be rotatable about the axis 705.

As illustrated in FIG. 7B, the swivel structure (e.g., swivel structure 106, previously described in connection with FIG. 1) can include a swivel hinge 734 and the swivel plate 735. The swivel hinge 734 can be connected to the rail structure (e.g., rail structure 108, previously described in connection with FIG. 1).

The swivel plate 735 can be connected to the tilt structure (e.g., tilt structure 104, previously described in connection with FIG. 1), where the tilt structure can be connected to the housing 702 (e.g., illustrated in FIG. 7B as a dashed line). As used herein, the term “swivel plate” refers to a device which rotates relative to a hinge. For example, the swivel plate 735 can rotate relative to the swivel hinge 734. Rotation of the swivel plate 735 can cause rotation of the tilt structure and the housing 702. That is, the housing 702 and the tilt structure are rotatable about the swivel structure in response to the swivel plate 735 rotating about the swivel hinge 734.

The swivel plate 735 can rotate about the axis 705. For example, a user may rotate the housing 702 (e.g., and the swivel plate 735) about the axis 705 such that the imaging device 740 is facing a different direction.

As previously described in connection with FIG. 6, the imaging device 740 can be electrically connected to a processor included in a computing device housing via the electrical pathway 738. The electrical pathway 738 can be routed from the imaging device 740 through the aperture 736 and to the processor as indicated in FIG. 7B.

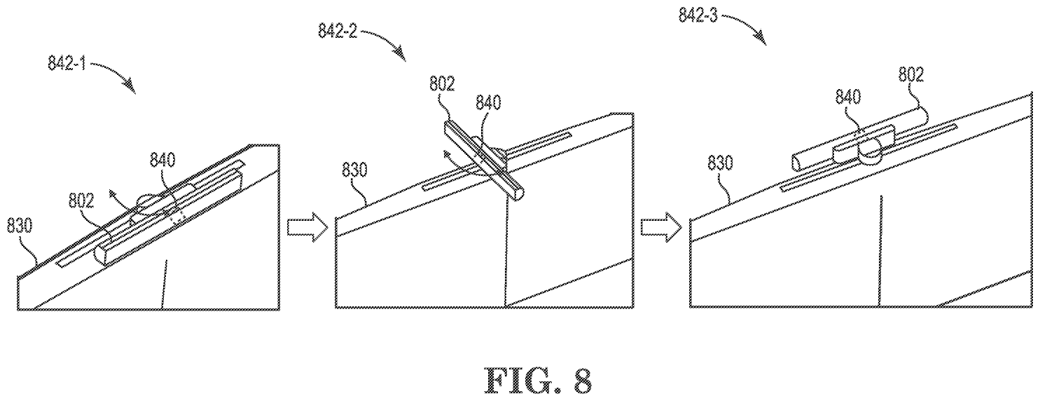

During rotation of the swivel plate 735, the electrical pathway 738 can rotate with the swivel plate 735. The swivel plate 735 may therefore be rotated from one side of the aperture 736 to the other. However, the swivel plate 735 may not rotate further, as either side of the aperture 736 can prevent the electrical pathway 738 from rotating further. Accordingly, as oriented in FIG. 7B, the swivel plate 735 can rotate in one direction (e.g., counterclockwise) by 180°, and then rotated the opposite direction (e.g., clockwise) by another 180°, as is further described in connection with FIG. 8.

FIG. 8 is a perspective view of an example of a housing 802 being rotated relative to a computing device housing 830 for translatable housings consistent with the disclosure. The housing 802 may be rotated from a first position 842-1 to a second position 842-2 to a third position 842-3, as is further described herein.

As illustrated in FIG. 8, the housing 802 and the imaging device 840 can be facing in a direction towards a user who may be utilizing a computing device associated with the computing device housing 830. In an event the user may want to adjust the housing 802, the user may rotate the housing 802 clockwise (e.g., as oriented in FIG. 8) from the first position 842-1 to the second position 842-2.

At the second position 842-2, the imaging device 840 can be facing in a direction substantially perpendicular to the user. The user may desire to further adjust the housing 802. Therefore, the user may rotate the housing 802 further clockwise from the second position 842-2 to the third position 842-3. At the third position 842-3, the imaging device 840 can be facing in a direction that is opposite from the first position 842-1. That is, the imaging device 840 can be facing in a direction at the second position 842-3 that is 180° (e.g., or substantially 180°) opposite from the first position 842-1.

The imaging device 840 may be utilized to capture images while at the third position 842-3. For example, an image may be captured by a security guard of a building visitor while the imaging device 840 is at the third position 842-3. As another example, the imaging device 840 may capture images of a meeting, and at the conclusion of the meeting the imaging device 840 may be rotated back to the first position 842-1.

To rotate the imaging device 840 back to the first position 842-1 of the housing 802, the housing can be rotated counterclockwise 180°. For example, the housing 802 may be moved from the third position 842-3 to the second position 842-2 and back to the first position 842-1. In some examples, the housing 802 may not be rotated clockwise another 180° from the third position 842-3 of the housing 802, as the electrical pathway from the imaging device 840 through the aperture of the swivel hinge to the processor of the computing device associated with the computing device housing 830 may be damaged.

Translatable housings according to the disclosure can allow for an imaging device housing to be tilted, rotated, and/or translated to a user's desired placement in order to efficiently capture images. Further, the use of multiple imaging devices to capture images on multiple sides of the imaging device housing can be avoided. Accordingly, such an approach can provide an easily manipulated imaging device housing and imaging device that can provide cost savings as compared with previous approaches.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a housing;
a tilt structure connected to the housing;
a swivel structure connected to the tilt structure; and
a rail structure connected to the swivel structure, wherein the rail structure comprises a sliding mechanism to interface with a track such that the housing is translatable along the track.

2. The apparatus of claim 1, wherein the sliding mechanism includes a wheel to interface with the track such that the wheel is to rotate in response to the housing translating along the track.

3. The apparatus of claim 1, wherein the sliding mechanism includes a drum to interface with the track such that the drum is to slide along the track in response to the housing translating along the track.

4. The apparatus of claim 1, wherein the sliding mechanism includes a channel beam to interface with the track such that the channel beam is to slide along the track in response to the housing translating along the track.

5. The apparatus of claim 1, wherein the swivel structure includes:
a swivel plate connected to the tilt structure; and
a swivel hinge connected to the rail structure.

6. The apparatus of claim 5, wherein the housing and the tilt structure are rotatable about the swivel structure in response to the swivel plate rotating about the swivel hinge.

7. An apparatus, comprising:
a housing; and
a tilt structure, wherein the tilt structure includes:
an attachment plate connected to the housing; and
a tilt ramp to interface with the attachment plate such that the housing is tiltable via the tilt ramp;
a swivel structure connected to the tilt ramp such that the housing and the tilt structure are rotatable about the swivel structure; and
a rail structure connected to the swivel structure, wherein the rail structure comprises a sliding mechanism to interface with a track such that the housing, the tilt structure, and the swivel structure are translatable along the track.

8. The apparatus of claim 7, wherein the tilt ramp includes a tilt track.

9. The apparatus of claim 8, wherein the attachment plate includes a protrusion to interface with the tilt track such that the protrusion is translatable along the tilt track to cause the housing to be tiltable via the tilt ramp.

10. The apparatus of claim 8, wherein the attachment plate includes a spindle to interface with the tilt track such that the spindle is translatable along the tilt track to cause the housing to be tiltable via the tilt ramp.

11. The apparatus of claim 7, wherein the sliding mechanism includes a wheel connected to the sliding mechanism via an axle, wherein the wheel is to interface with the track such that the housing is translatable along the track via the wheel.

12. A system, comprising:
a computing device housing comprising a frame and a track; and
an imaging device housing, comprising:
a housing;
a tilt structure connected to the housing such that the imaging device housing is tiltable;
a swivel structure connected to the tilt structure such that the housing and the tilt structure are rotatable about the swivel structure; and
a rail structure connected to the swivel structure, wherein the rail structure comprises a sliding mechanism to interface with the track such that the housing, the tilt structure, and the swivel structure are translatable along the track.

13. The system of claim 12, wherein the imaging device housing includes an imaging device.

14. The system of claim 13, wherein:
the swivel structure includes a swivel hinge having an aperture; and
the imaging device is electrically connected to a processor included in the computing device housing via an electrical pathway from the imaging device through the aperture of the swivel hinge to the processor.

15. The system of claim 12, wherein the imaging device housing is detachable from the computing device housing.
